(19) United States
(12) Patent Application Publication
(10) Pub. No.: US 2023/0258359 A1
(43) Pub. Date: Aug. 17, 2023

(54) Control Application for a System of Networked Air Filtering Appliances

(71) Applicant: NuWave, LLC, Vernon Hills, IL (US)

(72) Inventors: Jung S. Moon, Long Grove, IL (US); Byung Gab Choi, Lake Villa, IL (US); James Moon, Vernon Hills, IL (US); Zeng Qing Ping, Shanwei City (CN); Kim Jong Rok, Seoul (KR); Luo Fei, Foshan City (CN)

(21) Appl. No.: 17/651,138

(22) Filed: Feb. 15, 2022

(51) Int. Cl. F24F 11/77; F24F 11/52; F24F 11/58; H04W 4/38; G06F 3/0482

(52) U.S. Cl. CPC F24F 11/77; F24F 11/52; F24F 11/58; H04W 4/38; G06F 3/0482

(57) ABSTRACT

A mobile device used for controlling a plurality of air filtering units includes a display, at least one processor, and memory stored instructions that, when executed by the at least one processor, cause the mobile device to perform specific operations. The specific operations include displaying a graphical interface having icons which corresponds to either a preset operation or a control feature of the air filtering units, assigning each air filtering unit to a collection of air filtering units, navigating the graphical interface to input, by a user, a single set of appropriate operating parameters for the stored collection of units, and sending the operating parameters to each air filtering unit assigned to the collection via a wireless network.

### TECHNICAL FIELD OF THE INVENTION

The present invention relates to control applications. More specifically, the invention relates to control applications for a single appliance as well as a network of appliances.

### BACKGROUND OF THE INVENTION

With a growing focus on clean air and an ever-changing definition of what it means to have clean air, air purifying systems are becoming more prevalent in home, office, and industry. As disclosed in co-pending U.S. patent application Ser. No. 17/646,086, titled “Air Purifying System,” these systems have the ability to reduce air pollutants, including pollen, dust, smoke, viruses and other particulates, by up to 99.99%. The '086 application is hereby incorporated by reference. However, individual units are limited as to how much air they can take in and clean, so larger areas require the use of multiple units.

For example, an office building, a daycare, or a school building could require the use of numerous air purifying units to achieve a desired clean air quality. While controlling the operation of a single unit can be accomplished using ubiquitous Wi-Fi and BLUETOOTH® technology, the task becomes somewhat daunting as the number of air cleaning systems requiring control increases. Determining where to place each of the units and periodically changing and/or cleaning the numerous filters are initial considerations which make coordinating maintenance, operation, and location of just two individual air purifying systems a difficult undertaking. Where the use of three units is required; four units; 10 or more units, accessing operational control of each unit, especially using Wi-Fi and BLUETOOTH® connectivity, becomes increasingly confusing and difficult.

For this reason, a control application is needed which can handle multiple units. Further, a control application which allows individual units to be grouped together to better coordinate operation would be beneficial. Until the invention of the present application, these and other problems in the prior art went either unnoticed or unsolved by those skilled in the art. The present invention provides a control application which performs multiple functions with the associated air purifying devices without sacrificing operational features, designs, style or affordability.

### SUMMARY OF THE INVENTION

There is disclosed herein an improved mobile device having a control app for controlling air filtering systems, as well as a method for controlling such air filtering systems. The system and method avoid the disadvantages of prior systems and methods while affording additional structural and operating advantages.

Generally speaking, the mobile device used for controlling a plurality of air filtering units comprises a display, at least one processor, and memory stored instructions that, when executed by the at least one processor, cause the mobile device to perform specific operations.

In a preferred embodiment, the specific operations comprise steps of displaying a graphical interface having a plurality of icons, wherein each of the plurality of icons corresponds to one of either a preset operation or a control feature of the plurality of air filtering units; linking the graphical interface individually to each of the plurality of air filtering units through a wireless network; assigning each of the individually linked plurality of air filtering units to at least one collection of air filtering units; naming and storing the at least one collection of air filtering units; navigating the graphical interface in response to a user selecting one of the plurality of icons; inputting, by a user, a single set of appropriate operating parameters for the named and stored at least one collection of air filtering units based on the icon selected by a user; and sending the inputted single set of operating parameters to each air filtering unit assigned to the at least one collection of air filtering systems via the wireless network to thereby control the air filtering units together.

In specific embodiments of the disclosed mobile device and app, the graphical interface comprises a plurality of menu screens. Further, the icons corresponding to control features of the plurality of air filtering units comprise a power on/off button, a timer button, a sleep button, an alarm button, and a fan speed button.

In still other specific embodiments of the disclosed mobile device and app, the memory stored instructions that, when executed by the at least one processor, cause the mobile device to perform operations further comprises receiving sensor information from the plurality of air filtering units, and responding to the sensor information received from the plurality of air filtering units.

Preferably, the at least one collection of air filtering units comprises a hierarchy of at least two levels, and most preferably at least three levels. The hierarchy of at least two levels comprises at least one first level collection including at least two air filtering units selected from the plurality of air filtering units, and at least one second level collection including at least two first level collections. Likewise, the hierarchy of at least three levels comprises at least one first level collection including at least two air filtering units selected from the plurality of air filtering units, at least one second level collection including at least two first level collections, and at least one third level collection including at least two second level collections. Preferably, the graphical interface of the mobile app comprises icons corresponding to each of the at least three levels in the hierarchy.

Generally speaking, as to the method for remotely controlling a plurality of air filtering units, the method comprises the steps of connecting each of a plurality of air filtering systems to a wireless network, each of the connected air filtering systems being positioned in an area; connecting a mobile device having a display, at least one processor, and memory, to the wireless network, wherein the memory includes stored instructions that, when executed by the at least one processor, cause the mobile device to perform operations, wherein the operations comprise;
displaying a graphical interface having a plurality of icons, wherein each of the plurality of icons corresponds to one of either a preset operation or a control feature of the plurality of air filtering units;
linking the graphical interface individually to each of the plurality of air filtering units through a wireless network;
assigning each of the individually linked plurality of air filtering units to at least one collection of air filtering units;
naming and storing the at least one collection of air filtering units;
navigating the graphical interface in response to a user selecting one of the plurality of icons;
inputting, by a user, a single set of appropriate operating parameters for the named and stored at least one collection of air filtering units based on the icon selected by a user; and
sending the inputted single set of operating parameters to each air filtering unit assigned to the at least one collection of air filtering systems via the wireless network to thereby control the air filtering units together.

In specific embodiments, the method for remotely controlling a plurality of air filtering units further comprising continually receiving air quality data from the at least one collection of air filtering systems, and determining the air quality in an area, and alerting when the air quality is below a predetermined threshold. Preferably, the inputted single set of operating parameters is based on the determined air quality in an area.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings, embodiments thereof, from an inspection of which, when considered in connection with the following description, the subject matter sought to be protected, its construction and operation, and many of its advantages should be readily understood and appreciated.

FIG. 1 is an exemplary floor plan showing a distribution and grouping of air filtering units in six rooms and a hallway;

FIG. 2 is an exemplary illustration of multiple floor plans in a single building showing a distribution and grouping of air filtering units;

FIG. 3 is an exemplary illustration of multiple buildings with multiple floor plans showing a distribution and grouping of air filtering units;

FIG. 4 is a collection of four exemplary screen shots of a graphical interface for the disclosed control app on a smart phone;

FIG. 5 is a collection of three additional exemplary screen shots of a graphical interface for the disclosed control app on a smart phone;

FIG. 6 is a screen shot of an alternate embodiment of a screen for a graphical interface for the disclosed control app;

FIG. 7 is another screen shot of an alternate embodiment of a screen for a graphical interface for the disclosed control app;

FIG. 8 is still another screen shot of an alternate embodiment of a screen for a graphical interface for the disclosed control app;

FIG. 9 is still another screen shot of an alternate embodiment of a screen for a graphical interface for the disclosed control app;

FIG. 10 is a first portion of an operational flow chart which illustrates screen shots of at least one embodiment of the disclosed control app;

FIG. 11 is a second portion of the operational flow chart which connects to FIG. 10 via arrow (D);

FIG. 12 is a third portion of the operational flow chart which connects to FIG. 10 via arrows (A), (B) and (C); and

FIG. 13 is a fourth portion of the operational flow chart which connects to FIG. 12 via arrow (E).

### DETAILED DESCRIPTION OF THE INVENTION

While this invention is susceptible of embodiments in many different forms, there is shown in the drawings and will herein be described in detail at least one preferred embodiment of the invention with the understanding that the present disclosure is to be considered as an exemplification of the principles of the invention and is not intended to limit the broad aspect of the invention to any of the specific embodiments illustrated.

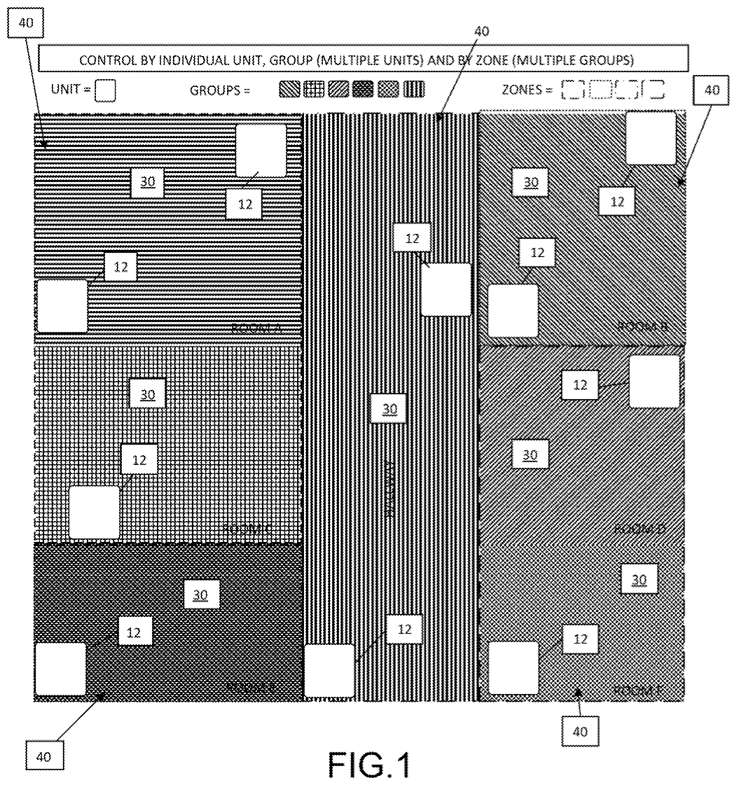

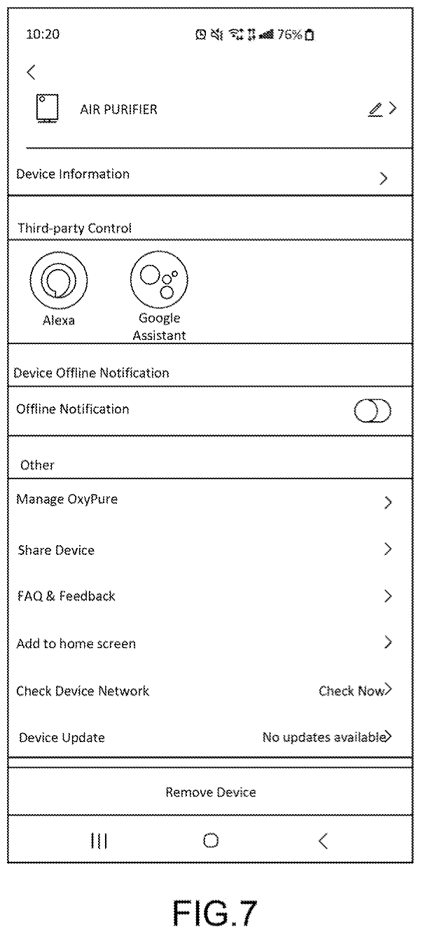

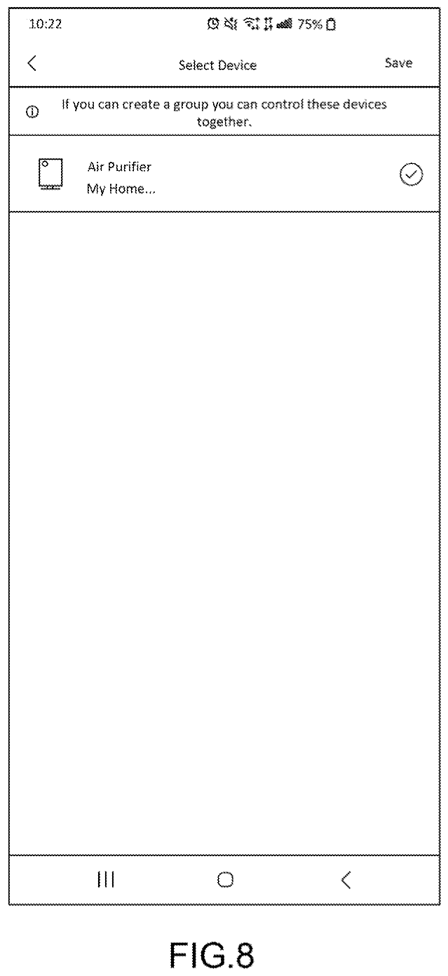

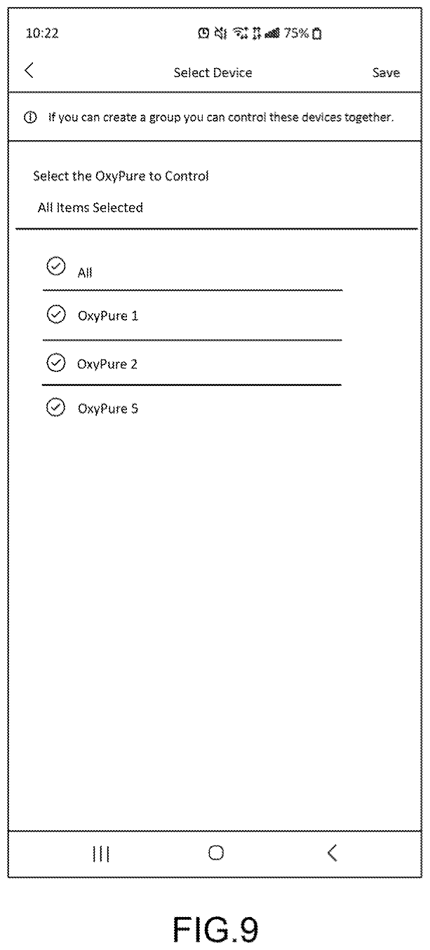

Referring to FIGS. 1-13, there is illustrated functional aspects, features, components, and real applications for a control application, generally designated by the numeral 10. The particular illustrated control application (aka control app) 10 is for networked air purifying units 12. However, while all the embodiments illustrated are directed to both a cloud or server-based app and methods for controlling multiple air purifying units 12, it should be understood that the principles of the invention can be more broadly applied to operational control of electronic appliances including, for example, cooling and heating units, fans, and the like (collectively, “units 12”).

The control app 10 is preferably loaded as operating instructions onto a mobile device, such as a smartphone, tablet, laptop or the like. However, many of the program instructions may be stored on at least one server which is accessible to the mobile device having the control app 10 loaded thereon. In a preferred embodiment, the mobile device includes a display, at least one processor, and memory for storage of control app 10 instructions. When executed by the at least one processor of the mobile device, specific operations are performed by the mobile device in connection with the plurality of air filtering units 12. The control app 10 and instructions can be more readily understood from the following description of at least one preferred embodiment in conjunction with the appended drawing figures.

With reference to FIG. 1, an important feature of the disclosed control app 10 is the ability to not only control individual units 12, but to also control groups 30 (i.e., multiple units 12), zones 40 (i.e., multiple groups 30), and locations 50 (i.e., multiple zones 40). Controlling individual units 12 involves the control app 10 connecting to at least one unit 12—though multiple units can be individually controlled—and setting and/or controlling individual operating parameters of the connected unit(s) 12. However, by linking one or more units 12 into a group 30, each of the units 12 in any group could be simultaneously controlled by the control app 10 with identical operating parameters by a single user input. A group 30 may be multiple units 12 positioned within, for example, a room or an open space (e.g., hallway or atrium) in a building. A zone 40 is when preferably a plurality of groups 30 are linked and simultaneously controlled by the control app 10. A zone 40 may be, for example, a large open space or multiple rooms—i.e., groups—in a building. Finally, the control app 10 can control a location 50, which may include a plurality of groups 30 and/or zones 40. A location 50 may be an entire building, for example, comprised of at least two zones 40, each being comprised of a plurality of groups 30 having at least one unit 12.

The disclosed control app 10 includes preset programming to facilitate and coordinate operation of individual units 12, groups 30, zones 40 and/or locations 50 (interchangeably and collectively referred to herein as “systems”). Just a few of the features of the control app 10 include automated responses, tracking of air quality data, advanced purchasing of replacement parts, and alerts.

Automated response: A user—i.e., the person or persons having access to the control app—can set parameters based on the scope of data received from a unit 12. These parameters can be based on, for example, air quality and location of each unit 12. Based on air quality data and cross-referencing with each unit's location, an automated operation schedule can be implemented by the control app 10. That is, the app 10 can continuously receive data on air quality based on the average of multiple unit readings and determine to start an air filtering sequence (e.g., “Ultimate Clean” mode) by sending an appropriate signal to all relevant units 12. Once the data indicates, a signal can be sent to return units to normal operation.

Track Air Quality Data: The app can store data for a given period of time and determine areas of greater concern of air quality based on, for example, the frequency of air filtering corrections made in a given time period (e.g., week or month). Such data can be used to determine whether more units might be required to improve air quality issues or uncover a greater problem in the area that may need addressing by an institution.

The app can take readings regarding air quality from each unit 12 within a system of units—i.e., group 30, zone 40 or location 50—and average the data for a specific area. The individual readings for each of a plurality of units within any given area can provide important information about a zone or region. However, an averaged value for all the units within the zone or region, displayed graphically in the app, provides a general air quality condition to allow a user to properly manage the units 12 to improve that general air quality.

In-App Purchase (e.g., replacement filters): The control app 10 can keep track of, for example, filter changes based on alerts sent from a unit 12. The app 10 can log a series of filter changes and determine when a user should clean or purchase new filters. This process can be automated and may include subscription capabilities for filter replacements. A payment gateway process may be used to replenish customers with filters automatically based on real-time data from each air filtering unit 12.

Alert system: As air quality readings are taken, the control app 10 could potentially interpret serious air situations. With specific threshold levels preset at the control app 10, the simultaneous triggering of an individual unit 12, a group 30 (i.e., multiple units 12), a zone 40 (i.e., multiple groups 30), or location 50 (i.e., multiple zones 40) could be considered an emergency situation (e.g., high smoke readings) requiring alerts to either a user, an institution (e.g., school office, building management) or local fire departments. Ultimately, there are ways to use sensors on each unit 12, whether as individual units or as a collective, to determine changes in air quality, and assign various alerts to elicit a response by either the air filtering units 12 or personnel.

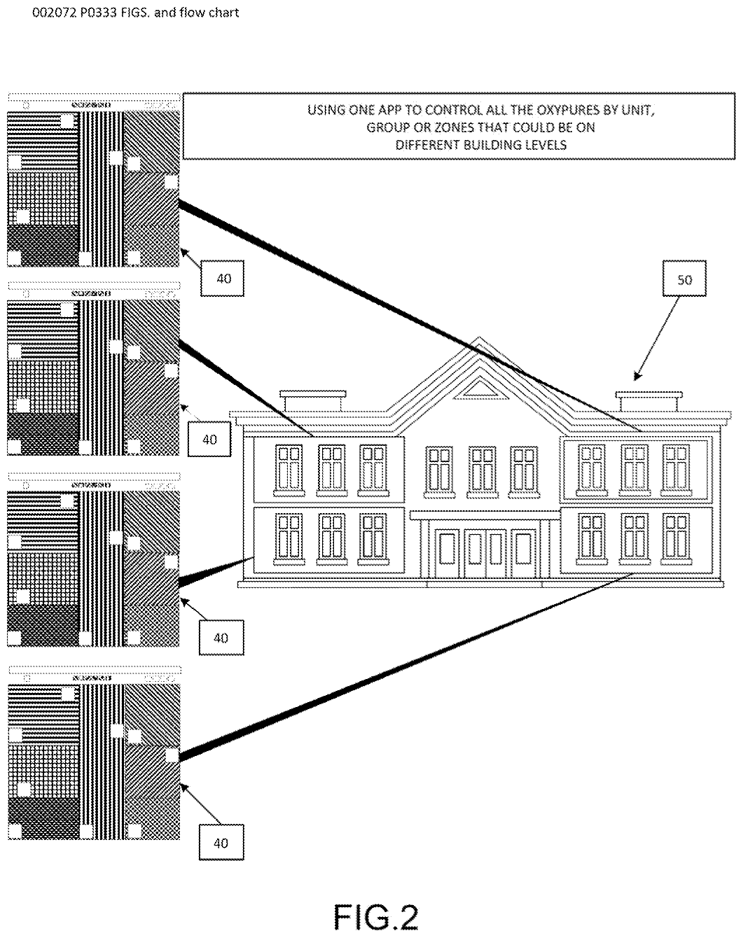

FIG. 2 illustrates an exemplary use of the control app 10 for controlling numerous units 12 within a school building. As shown, the building is divided into east and west wings, each having an upper and lower level—i.e., four distinct areas. Within each of the four areas is six classrooms (24 total classrooms) and a hallway (four hallways). Following the layout of FIG. 1, in one embodiment the classrooms on each floor and wing would be assigned to one of seven groups 30—i.e., all Room A's being a group, all Room B's another group, all Room C's another group, etc. Likewise, the seven groups would then be assigned to one of four zones 40. Finally, the collection of units 12, groups 30, and zones 40 can be assigned a single location 50—i.e., the school. Alternatively, while each of the six classrooms and hallway in each of the four upper and lower wings could be assigned a group 30, the collection of rooms on each floor and wing could be designated as a zone 40.

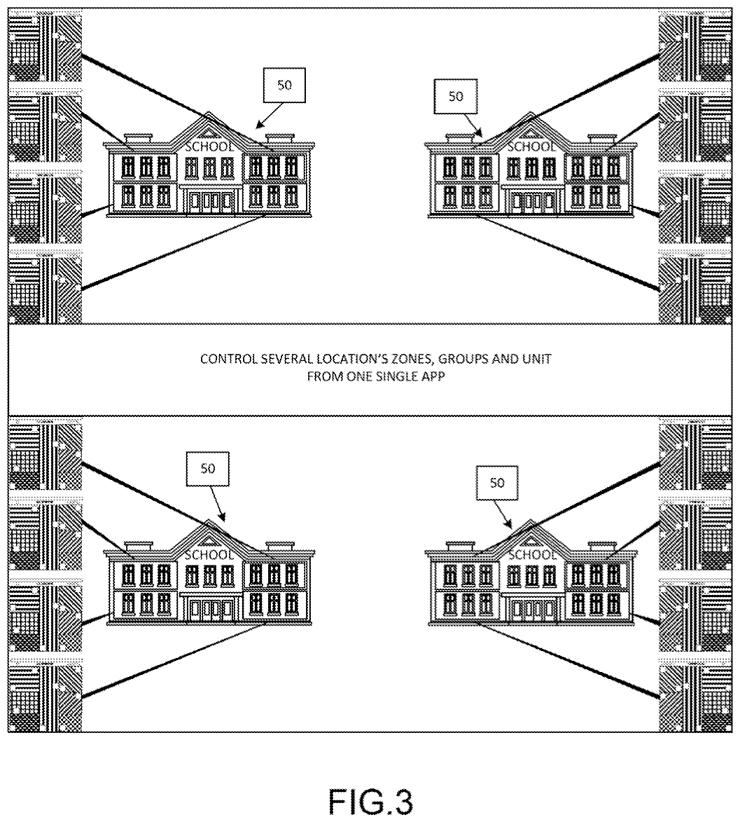

FIG. 3 is an extension of the concept in FIG. 2 and illustrates how several locations 50 (e.g., four different schools) might be divided. This would allow the disclosed control app 10 to provide control at: (1) a very fine level, i.e., 160 individual units 12; (2) a fine level, i.e., 96 groups 30; (3) a coarse level, i.e., 16 zones 40; and (4) a very coarse level, i.e., 4 locations.

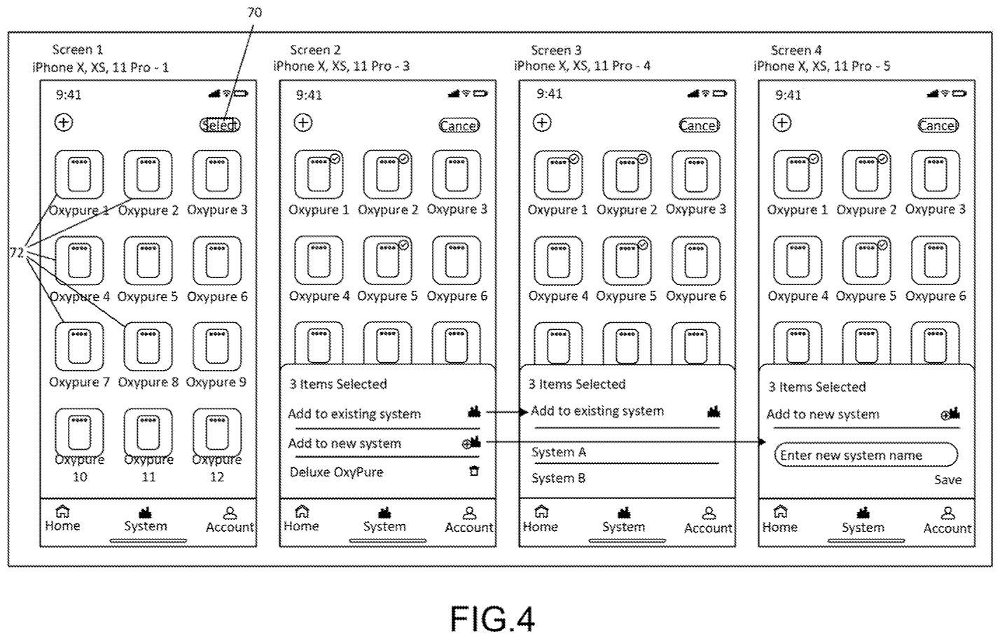

Referring now to FIG. 4, four screen shots of an embodiment of the control app 10 are illustrated. In Screen 1, an embodiment of the control app 10 homepage is shown. This screen is used to show all available and connected air filtering units 12. The connection is preferably done automatically, as each unit can be “found” via Wi-Fi, BLUETOOTH®, or through a similar wireless connectivity. The “select” button 70 allows for creation of a collection of units 12 indicated by an icon 72, much like selecting photos on a mobile device is done to create or add to an album. Each of the desired units 12 shown on the screen by a linked icon 72 can be tapped for selection. Once a user has selected the desired icons 72 representing each of the connected air purifying units 12 (indicated by shaded area and dot in upper right corner of unit, as shown in Screen 2), tapping the “select” button 70 brings up a menu providing three-options: add to existing system (Screen 3); add to a new system (Screen 4); and delete the selected unit(s).

The menu of Screen 3 shows two systems saved on the control app 10—i.e., System A and System B. Either of these two systems can be selected by tapping on the menu listing. Similarly, the menu for “Add to new system” shown in Screen 4 allows entry of a name for the new system for the selected units.

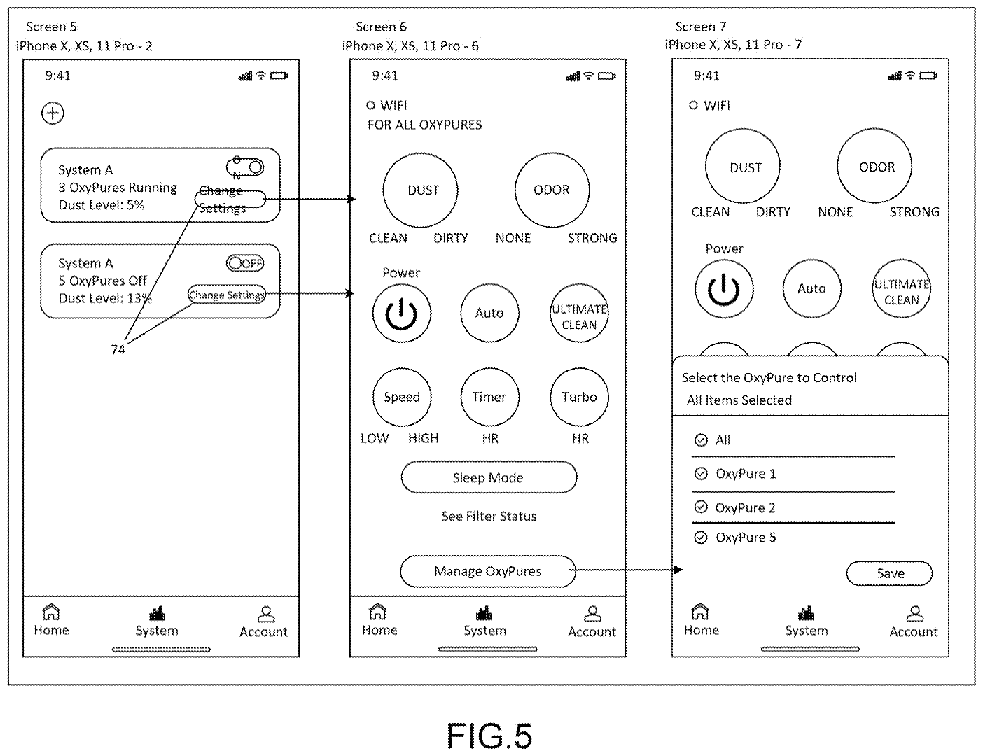

Referring now to the screen shots of FIG. 5, these interfaces provide a dashboard showing each connected group of air filtering units 12. As shown in Screen 5, a user is provided with high-level information regarding each unit 12, group 30, zone 40 and location 50. The control app 10 allows a user to quickly turn on/off all connected units—System A is “on” and includes three connected units 12, while System B is “off” and includes five connected units 12. Changing the settings for any unit 12, group 30, zone 40 or location 50 can be done by clicking on the “change settings” menu item 74. The interface of Screen 6 is used to collectively control units in a system. As illustrated, this exemplary interface allows a user to remotely check “dust” and “odor” conditions, turn units 12 on/off, set auto on/off parameters, turn on presets (e.g., “ultimate clean” and “turbo”), control fan speed, and set a timer. A user may even be able to check “filter status” and set the system into sleep/wake mode.

Finally, the interface of Screen 7 is used to select individual units 12 within a system to control. The interface may show all available units currently being controlled under a designated group (e.g., System A). Units may be removed or added through this interface.

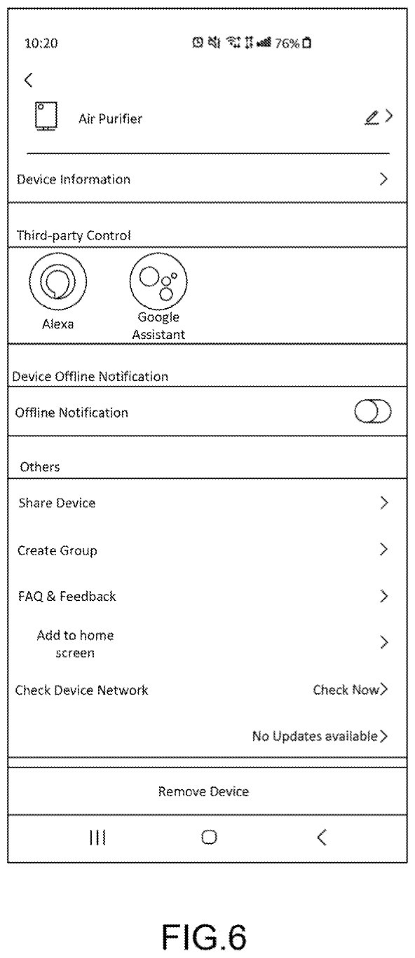

Turning now to FIGS. 6-9, alternate graphic screen interfaces are illustrated. These interfaces provide similar functionality to those of FIGS. 2 and 3. Each connected unit can be added to a group, updated, monitored, and controlled. All the units within a group can be controlled together as well.

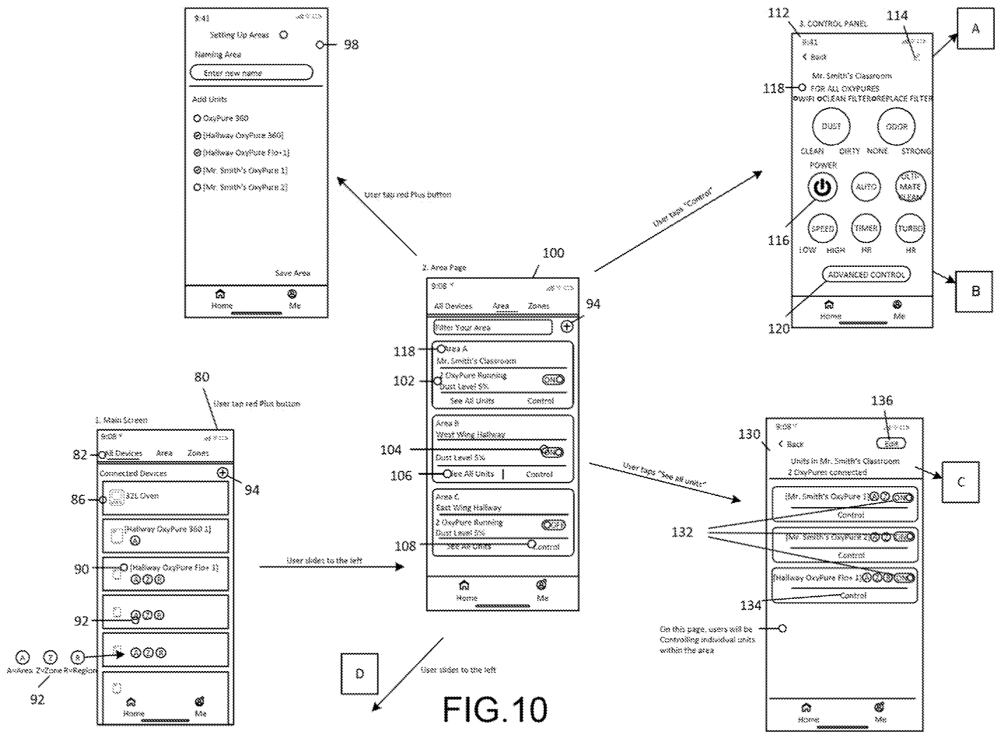

As can be seen in the flowchart of FIG. 10, the exemplary graphical interface facilitates control of one unit 12 or many units 12. The specific details of the flowchart of FIG. 10 are intended to illustrate only one embodiment of the Control App 10 interface. Alternate features, functions, and information can be readily added by a person of skill in the art, as well as many of the illustrated features, functions, and information can be readily removed, if desired.

Beginning with the main screen 80, there is a sliding navigation bar 82 along the top with menu items including (reading left to right) “All Devices,” “Areas,” “Zones,” and “Regions.” The latter three items may correspond to “groups,” “zones,” and “locations” as described above. Screen 80 is currently set to “All Devices” and is displaying, by name, individual units 12 connected, via Wi-Fi, to the control app 10. Where other compatible electronic devices are also connected to the control app 10 (e.g., fans, ovens, etc.), they could be listed at the top of the screen, as shown by icon 86 for an oven. Further, unit names 90 and coded icon indicators 92 can be used to provide information on each unit—e.g., whether the unit is assigned to an area, zone and/or region. Other possible indicators may show a timer, on/off, filter status, or other operational parameters.

A “plus” icon 94 located just below the navigation bar 82 allows a user to go to the screen where individual units 12 can be added, automatically or manually, and named. As can be seen, this plus icon 94 appears on many of the control app 10 screens to allow adding and naming of areas, zones, and regions as well.

In the illustrated embodiment, moving to the right on the top navigation bar 82, brings up the screen 100 for “Areas.” When the number of systems being controlled exceeds the screen space provide—in the present case three—a user is able to scroll up and down to navigate through the list of systems. In the present embodiment, the number of units 12 currently running (for the selected area) and current air quality are displayed at 102. A toggle button 104 is also provided which allows a user to turn on and off all connected units of the selected Area at once. Just below the status bar 102 on Screen 100 are two additional buttons: “Control” 106 and “See all units” 108. In the set-up screen 98, accessed by tapping the plus icon 94, a user selects connected units 12 to add to a system (e.g., a group, zone, location). The system can then be named for ease of reference and saved for easy recall.

By tapping on the Control 108 button, a user is taken to Screen 112, the control panel screen. On Screen 112, an “Edit” icon 114 is positioned in the upper right corner and a status bar 116 is shown below the saved name 118 for the selected system. Screen 112 allows a user to turn units on/off, activate presets, control fan speed, set a timer, and enter “advanced controls”. Of course, other interface buttons may be provided in place of or in addition to the current buttons, for alternate embodiments.

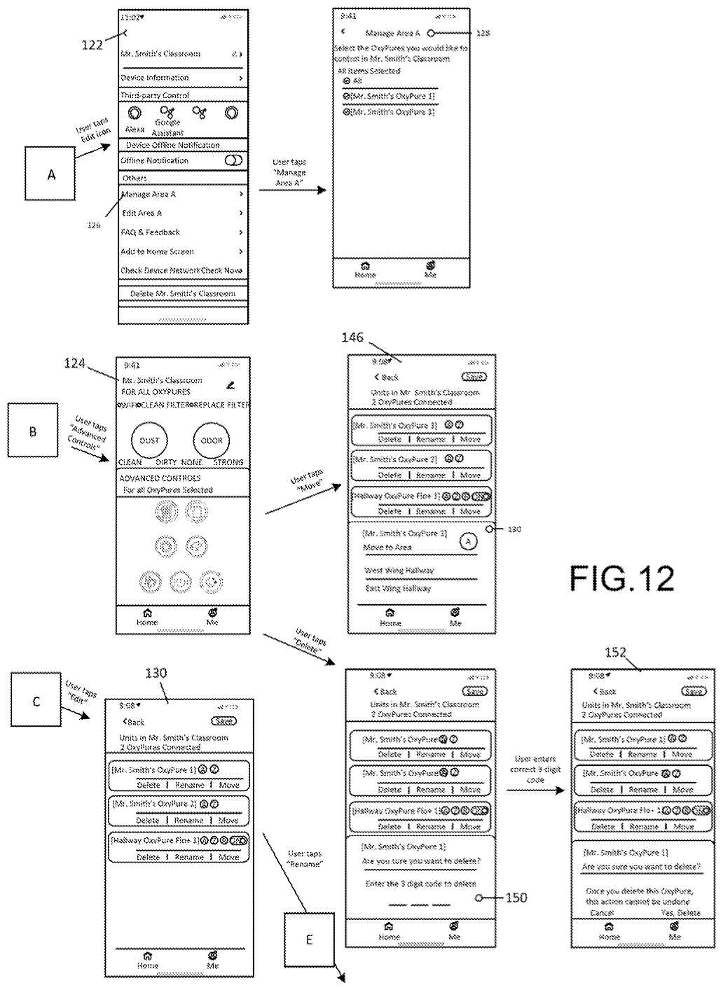

From the Control Panel Screen 112, a user may tap on either the Edit button 114 and move to Edit Screen 122 (follow Arrow A to FIG. 12), or the Advanced Control button 120 to move to Advance Control Screen 124 (follow Arrow B to FIG. 12). The illustrated Edit Screen 122 allows a user to set notifications, manage and edit the selected area (e.g., name, controlled units), review FAQ page, check device network, and delete the selected area. Tapping on the Manage Area button 126 takes a user to Manage Screen 128 where individual control of units within the selected Area can be controlled.

Tapping on the Advance Control button 120 of Control Panel Screen 112 takes a user to the Advance Control Screen 124. In this Screen 124 a user may be able to check filters, order replacement filters, access preset controls, and other such advanced features. Again, these features and functions are merely exemplary.

Returning to Area Screen 100, a user may also tap on the See All Units button 108. This action takes the user to Screen 130 where individual units 12 are listed with system icons 92 (see above discussion). A toggle button 132 allows each of the individual units to be switched on/off. A control button 134 under each unit name takes the user to the individual control screen for the corresponding unit. An edit button 136 in the top right corner of Screen 130 brings a user to an Edit Screen 140 (follow Arrow C to FIG. 12).

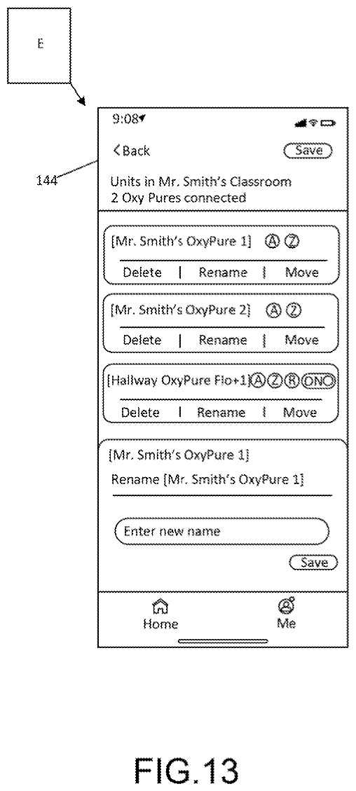

For each unit 12 of the selected Area, Screen 140 presents three options: delete, rename, and move. Each of these options takes the user to one of Screens 142, 144 (follow Arrow E to FIG. 13), and 146, respectively. If a user wishes to delete a unit from an Area, a secondary authentication—for example, entering a three-digit code—may be required, as shown in Screens 150 and 152.

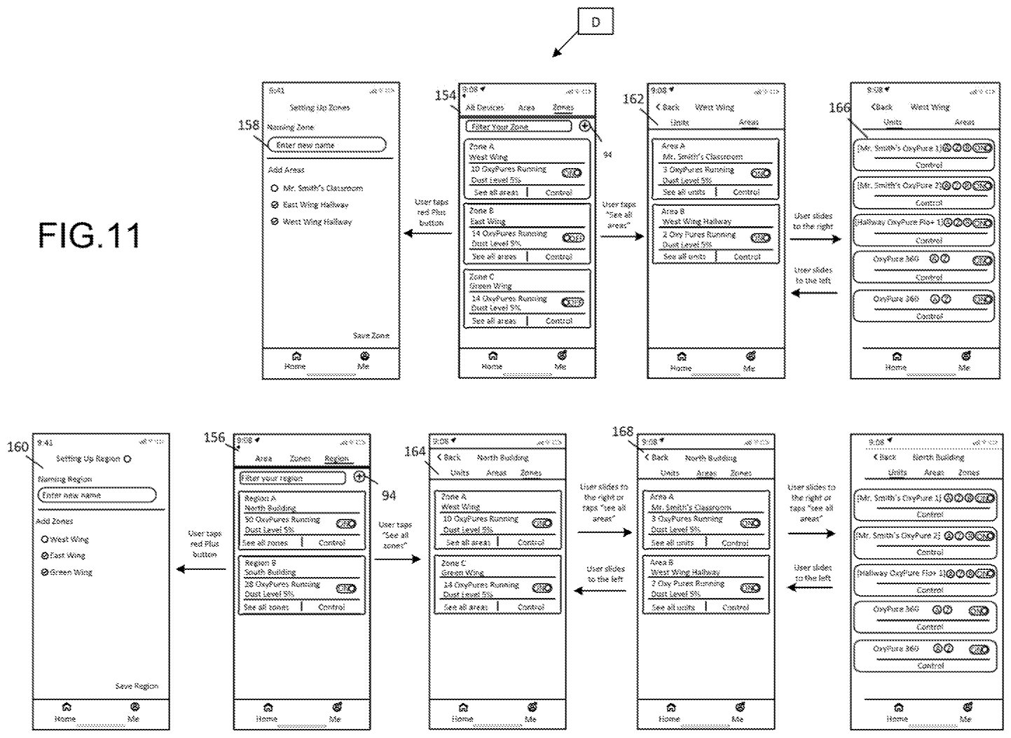

In addition to the Area Home Screen 100, a user can access a Zones Home Screen 154 and a Regions Home Screen 156 by swiping to the left at Main Screen 80 (follow Arrow D to FIG. 11).

FIG. 11 illustrates several of the screens encountered by a user for the disclosed embodiment. As can be seen, the interface screens for navigating the Zone and Region set-up are similar to the functions, features and information provided via the Area navigation described above. Once in the Zone Screen 154 or Region Screen 156, a user may navigate from the home screens to access set-up screens 158, 160, and move through the hierarchy of control screens 162, 164, and edit screens 166, 168, for any saved systems.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art

What is claimed is:

1. A mobile device used for controlling a plurality of air filtering units, the mobile device comprising:
a display;
at least one processor; and
memory stored instructions that, when executed by the at least one processor, cause the mobile device to perform operations comprising:
displaying a graphical interface having a plurality of icons, wherein each of the plurality of icons corresponds to one of either a preset operation or a control feature of the plurality of air filtering units;
linking the graphical interface individually to each of the plurality of air filtering units through a wireless network;
assigning each of the individually linked plurality of air filtering units to at least one collection of air filtering units;
naming and storing the at least one collection of air filtering units;
navigating the graphical interface in response to a user selecting one of the plurality of icons;
inputting, by a user, a single set of appropriate operating parameters for the named and stored at least one collection of air filtering units based on the icon selected by a user; and
sending the inputted single set of operating parameters to each air filtering unit assigned to the at least one collection of air filtering systems via the wireless network to thereby control the air filtering units together.

2. The mobile device of claim 1, wherein the graphical interface comprises a plurality of menu screens.

3. The mobile device of claim 1, wherein the icons corresponding to control features of the plurality of air filtering units comprise a power on/off button, a timer button, a sleep button, an alarm button, and a fan speed button.

4. The mobile device of claim 1, wherein the memory stored instructions that, when executed by the at least one processor, cause the mobile device to perform operations further comprising:
receiving sensor information from the plurality of air filtering units; and
responding to the sensor information received from the plurality of air filtering units.

5. The mobile device of claim 1, wherein the at least one collection of air filtering units comprises a hierarchy of at least two levels.

6. The mobile device of claim 5, wherein the hierarchy of at least two levels comprises at least one first level collection including at least two air filtering units selected from the plurality of air filtering units, and at least one second level collection including at least two first level collections.

7. The mobile device of claim 5, wherein the at least one collection of air filtering units comprises a hierarchy of at least three levels.

8. The mobile device of claim 7, wherein the hierarchy of at least three levels comprises at least one first level collection including at least two air filtering units selected from the plurality of air filtering units, at least one second level collection including at least two first level collections, and at least one third level collection including at least two second level collections.

9. The mobile device of claim 8, wherein the graphical interface comprises icons corresponding to each of the at least three levels in the hierarchy.

10. A method for remotely controlling a plurality of air filtering units comprising:
connecting each of a plurality of air filtering systems to a wireless network, each of the connected air filtering systems being positioned in an area;
connecting a mobile device having a display, at least one processor, and memory, to the wireless network, wherein the memory includes stored instructions that, when executed by the at least one processor, cause the mobile device to perform operations, wherein the operations comprise;
displaying a graphical interface having a plurality of icons, wherein each of the plurality of icons corresponds to one of either a preset operation or a control feature of the plurality of air filtering units;
linking the graphical interface individually to each of the plurality of air filtering units through a wireless network;
assigning each of the individually linked plurality of air filtering units to at least one collection of air filtering units;
naming and storing the at least one collection of air filtering units;
navigating the graphical interface in response to a user selecting one of the plurality of icons;
inputting, by a user, a single set of appropriate operating parameters for the named and stored at least one collection of air filtering units based on the icon selected by a user; and
sending the inputted single set of operating parameters to each air filtering unit assigned to the at least one collection of air filtering units via the wireless network to thereby control the air filtering units together.

11. The method for remotely controlling a plurality of air filtering units of claim 10, further comprising continually receiving air quality data from the at least one collection of air filtering systems.

12. The method for remotely controlling a plurality of air filtering units of claim 11, further comprising determining the air quality in an area, and alerting when the air quality is below a predetermined threshold.

13. The method for remotely controlling a plurality of air filtering units of claim 12, wherein the inputted single set of operating parameters is based on the determined air quality in an area.

14. The method for remotely controlling a plurality of air filtering units of claim 10, wherein assigning each of the individually linked plurality of air filtering units to at least one collection of air filtering units comprises grouping air filtering units based on location and proximity to one another.

15. The method for remotely controlling a plurality of air filtering units of claim 10, wherein the graphical interface comprises a plurality of menu screens.

16. The method for remotely controlling a plurality of air filtering units of claim 10, wherein the icons corresponding to control features of the plurality of air filtering units comprise a power on/off button, a timer button, a sleep button, an alarm button, and a fan speed button.

17. The method for remotely controlling a plurality of air filtering units of claim 10, wherein the operations further comprise:
receiving sensor information from the plurality of air filtering units; and
responding to the sensor information received from the plurality of air filtering units.

18. The method for remotely controlling a plurality of air filtering units of claim 10, wherein the at least one collection of air filtering units comprises a hierarchy of at least two levels.

19. The method for remotely controlling a plurality of air filtering units of claim 18, wherein the hierarchy of at least two levels comprises at least one first level collection including at least two air filtering units selected from the plurality of air filtering units, and at least one second level collection including at least two first level collections.

20. The method for remotely controlling a plurality of air filtering units of claim 18, wherein the at least one collection of air filtering units comprises a hierarchy of at least three levels.

21. The method for remotely controlling a plurality of air filtering units of claim 20, wherein the hierarchy of at least three levels comprises at least one first level collection including at least two air filtering units selected from the plurality of air filtering units, at least one second level collection including at least two first level collections, and at least one third level collection including at least two second level collections.

22. The method for remotely controlling a plurality of air filtering units of claim 21, wherein the graphical interface comprises icons corresponding to each of the at least three levels in the hierarchy.

23. The method for remotely controlling a plurality of air filtering units of claim 11, wherein the operations further comprise combining air quality data from each air filtering unit within the at least one collection of air filtering units to derive a general air quality condition.

24. The method for remotely controlling a plurality of air filtering units of claim 23, further comprising graphically displaying the derived general air quality condition.

25. The method for remotely controlling a plurality of air filtering units of claim 24, further comprising adjusting the single set of appropriate operating parameters based on the derived general air quality condition.
